(19) United States
(12) Patent Application Publication
(10) Pub. No.: US 2010/0181891 A1
(43) Pub. Date: Jul. 22, 2010

(54) Package Structure for Solid-State Lighting with Low Thermal Resistance

(76) Inventors: Cheng-Shih Lee, Pan Chiao City (TW); Hsin-Yi Hsieh, Pan Chiao City (TW); Shen-Chang Lin, Pan Chiao City (TW); Chou-Chih Yin, Pan Chiao City (TW)

Correspondence Address: SINORICA, LLC, 2275 Research Blvd., Suite 500, ROCKVILLE, MD, 20850, US

(21) Appl. No.: 12/688,964

(22) Filed: Jan. 18, 2010

(30) Foreign Application Priority Data
Jan. 20, 2009 (TW) 098102082

(51) Int. Cl. H01J 61/52

(52) U.S. Cl. 313/46

(57) ABSTRACT

A package structure for solid-state lighting with low thermal resistance is revealed. A solid-state light is set on a circuit board with high thermal conductivity. A connection layer is used for binding the circuit board with high thermal conductivity and the heat sink substrate. A first attachment layer is set between the heat sink substrate and the connection layer; and a second attachment is set between the connection layer and the circuit board with high thermal conductivity. The connection layer is made of metals or metallic composite materials with high heat dissipation and low thermal expansion coefficients. Thereby, the thermal resistance is lower than the structures according to the prior art. In addition, the thermal stress produced between the heat sink substrate and the circuit board with high thermal conductivity can be buffered by the connection layer for increasing lifetime of the package structure according to the present invention.

### FIELD OF THE INVENTION

The present invention relates generally to a package structure for solid-state lighting and, and particularly to a package structure for solid-state lighting with low thermal resistance.

### BACKGROUND OF THE INVENTION

FIG. 1A shows a structural schematic diagram of a chip-on-board (COB) package for solid-state lighting according to the prior art. As shown in the figure, a solid-state lighting chip 18 is bonded on a metal substrate (MCPCB) 12 by using silver adhesive 16, insulant die attach, or eutectic process. In addition, the substrate 12 is a metal-core printed circuit board (MCPCB) with an insulating material 14 thereon. However, the solid-state lighting chip 18 is set directly on the insulating material 14, which is a dielectric material with a poor thermal conducting property. Namely, the thermal resistance is high. Thereby, heat produced by the solid-state lighting chip 18 is uneasy to be conducted. Consequently, a large amount of heat is accumulated in the chip, deteriorating the light-emitting efficiency and lifetime of the solid-state lighting chip 18.

FIG. 1B shows a structural schematic diagram of a chip-on-board (COB) package for solid-state lighting according to another prior art. As shown in the figure, a solid-state lighting chip 28 is set on aluminum nitride (AlN) 26, which is set on a substrate 22. The substrate 22 is a metal substrate, and contacts the aluminum nitride 26 with a thermal grease 24. This type of package structure does not include an insulating material with high thermal resistance. However, the thermal conductance of the thermal grease is not high, and pressure has to be applied on the aluminum nitride 26 for reducing the interfacial thermal resistance. Thereby, it is not effective in reducing the overall thermal resistance of the package structure by binding with the substrate 22 underneath by adopting the thermal grease 24.

If the thermal resistance of a COB package structure for a solid-state lighting chip can be reduced, the light-emitting efficiency and lifetime of the chip can be improved accordingly.

### SUMMARY

An objective of the present invention is to provide a package structure for solid-state lighting with low thermal resistance and a method for manufacturing the same, which uses a connection layer to bind a heat sink substrate and a circuit board with high thermal conductivity to make the thermal resistance of said package structure for solid-state lighting with low thermal resistance is lower than the package structure according to the prior art. Thereby, the light-emitting efficiency and lifetime of the chip can be improved.

Another objective of the present invention is to use the connection layer as a buffer of thermal stress between the heat sink substrate and the circuit board with high thermal conductivity. Thereby, the reliability of said package structure for solid-state lighting with low thermal resistance can be enhanced.

The package structure for solid-state lighting with low thermal resistance according to the present invention comprises a heat sink substrate, a connection layer, a circuit board with high thermal conductivity, and a solid-state lighting. The connection layer is set on the heat sink substrate, and is made of metals or metallic composite materials with high heat dissipation and low thermal expansion properties. The circuit board with high thermal conductivity is set on the connection layer; and the solid-state lighting is set on the circuit board with high thermal conductivity. A first attachment layer is set between the heat sink substrate and the connection layer, and comprises a first metal layer and a second metal layer. A second attachment layer is set between the connection layer and the circuit board with high thermal conductivity, and comprises a third metal layer and a fourth metal layer. By means of the connection, the thermal resistance of the package structure for solid-state lighting with low thermal resistance can be reduced, and the thermal stress can be buffered. Thereby, the light-emitting efficiency and lifetime of the chip can be improved. In addition, because of the first attachment layer between the heat sink substrate and the connection layer and the second attachment layer between the connection layer and the circuit board with high thermal conductivity, the binding forces therebetween can be increased, and thus avoiding detachment of the heat sink substrate and the circuit board with high thermal conductivity owing to heat.

### BRIEF DESCRIPTION OF THE DRAWINGS

FIG. 1A shows a structural schematic diagram of a chip-on-board (COB) package for solid-state lighting according to the prior art;

FIG. 1B shows a structural schematic diagram of a chip-on-board (COB) package for solid-state lighting according to another prior art;

FIG. 2A shows a three-dimensional diagram according to a preferred embodiment of the present invention;

FIG. 2B shows an exploded view according to a preferred embodiment of the present invention;

FIG. 3A shows a three-dimensional diagram according to another preferred embodiment of the present invention;

FIG. 3B shows an exploded view according to another preferred embodiment of the present invention;

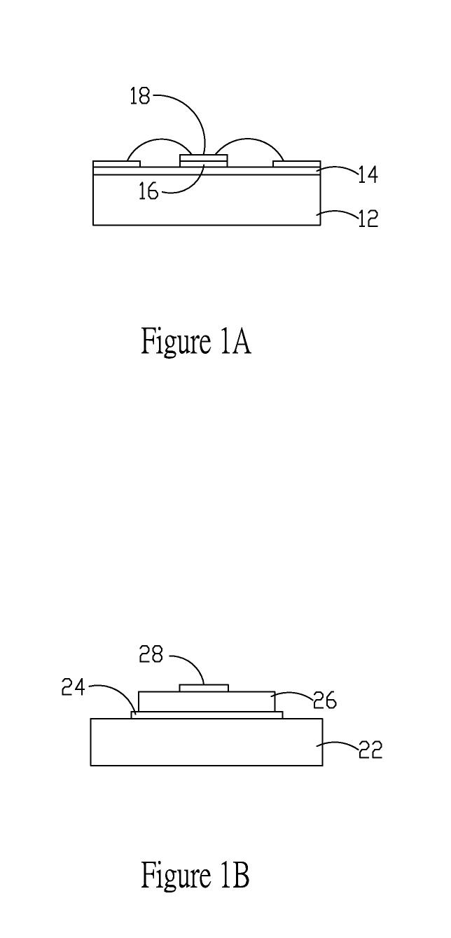

### DETAILED DESCRIPTION

In order to make the structure and characteristics as well as the effectiveness of the present invention to be further understood and recognized, the detailed description of the present invention is provided as follows along with preferred embodiments and accompanying figures.

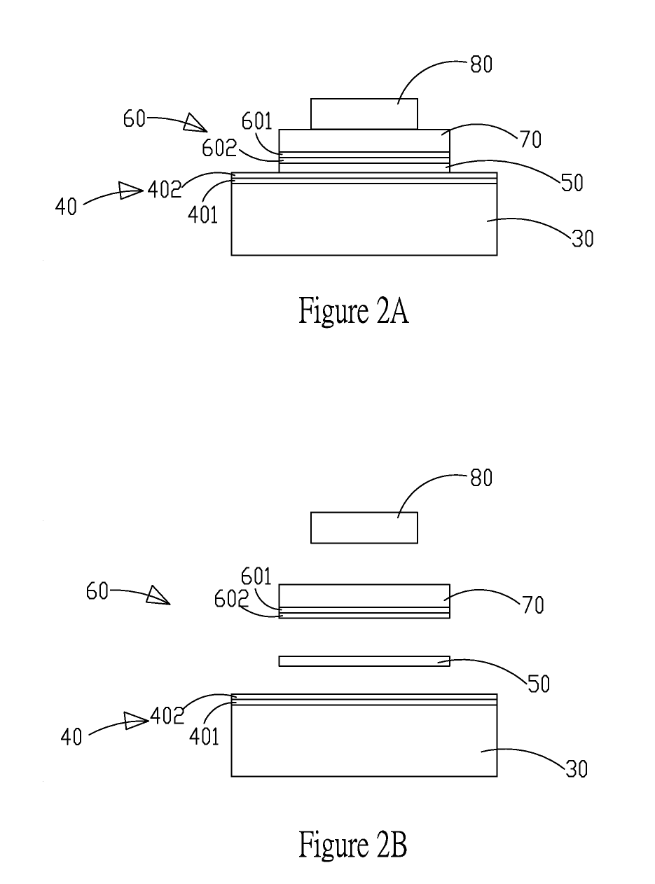

FIGS. 2A and 2B show a three-dimensional diagram and an exploded view according to a preferred embodiment of the present invention. As shown in the figures, the package structure for solid-state lighting with low thermal resistance according to the present invention comprises a heat sink substrate 30, a connection layer 50, a circuit board with high thermal conductivity 70, and a solid-state lighting (SSL) 80. The connection layer 50 is set on the heat sink substrate 30. The circuit board with high thermal conductivity 70 is set on the connection layer 50, and includes circuit layers with wiring, and series and parallel designs. The solid-state lighting 80 is set on the circuit board with high thermal conductivity 70, and is bound on the circuit layer of the circuit board with high thermal conductivity 70 using eutectic process.

The material of the heat sink substrate 30 comprises metals, which includes aluminum or copper. The material of the connection layer 50 comprises metals, alloys, or metallic composite materials, where the metals include indium (In). The thermal expansion coefficient of the connection layer 50 is less than 30(10 e-6/° C.), and the thermal conductivity is greater than 50 W/mK. The material of the circuit board with high thermal conductivity comprises ceramics or silicon (Si), where the ceramics include aluminum nitride (AlN) or aluminum oxide (Al₂O₃). According to the present preferred embodiment, the material of the heat sink substrate 30 is aluminum, the material of the connection layer 50 is indium, and the material of the circuit board with high thermal conductivity 70 is aluminum nitride. The thermal expansion coefficient of the semiconductor silicon of the solid-state lighting 80 is 4.2(10 e-6/° C.), and that of the aluminum nitride is 4.5(10 e-6/° C.). The two thermal expansion coefficients are close, enhancing the reliability between the solid-state lighting 80 and the circuit board with high thermal conductivity 70. Besides, the thermal stress between the heat sink substrate 30 and the circuit board with high thermal conductivity 70 can be absorbed by the connection layer 50.

Furthermore, the thermal conductivity of aluminum nitride is greater than 140 W/mK, the thermal conductivity of indium is approximately 86 W/mK, and the thermal conductivity of aluminum is approximate 180 W/mK. The thermal conductivity coefficients of these layers match to each other, and hence forming a good heat-conducting path. In the fabrication process of COB, the situation of the aluminum substrate contacting downwards with the insulation layer directly according to the prior art can be prevented. Thereby, the thermal spreading resistance can be reduced, reaching below 5° C./W experimentally.

Because the heat sink substrate 30 and the connection layer 50 are made of different materials, in order to increase binding of the heat sink substrate 30 and the connection layer 50, a first attachment layer 40 is set between the heat sink substrate 30 and the connection layer 50. The first attachment layer 40 includes a first metal layer 401 and a second metal layer 402. The first metal layer 401 is set on the heat sink substrate 30 by using electroplating or sputting or e-gun evaproator. The material of the first metal layer 401 includes titanium (Ti). In addition, the second metal layer 402 is set on the first metal layer 401 by, likewise, electroplating or sputting or e-gun evaproator. The material of the second metal layer 402 includes silver (Ag) or gold (Au). Then, the connection layer 50 is set on the second metal layer 402.

Similarly, a second attachment layer 60 is set between the connection layer 50 and the circuit board with high thermal conductivity 70. The second attachment layer 60 includes a third metal layer 601 and a fourth metal layer 602. The third metal layer 601 is set under the circuit board with high thermal conductivity 50. The material of the third metal layer 601 includes titanium (Ti). The fourth metal layer 602 us set under the third metal layer 601. The material of the fourth metal layer 602 includes silver (Ag) or gold (Au). Next, the circuit board with high thermal conductivity 70 is set on the connection layer 50 to make the connection layer 50 being set under the fourth metal layer 602.

By the deployment of the first and second attachment layers 40, 60, the binding between the heat sink substrate 30 and the connection 50 and the binding between the connection layer 50 and the circuit board with high thermal conductivity 70 are increased. Besides, detachment of the heat sink substrate 30 and the circuit board with high thermal conductivity 70 owing to heat can be avoided. Moreover, by using gold (Au) or silver (Ag) of the second and fourth metal layers 402, 602 to bind preferably with indium (In), the reliability of the package structure according to the present invention can be enhanced.

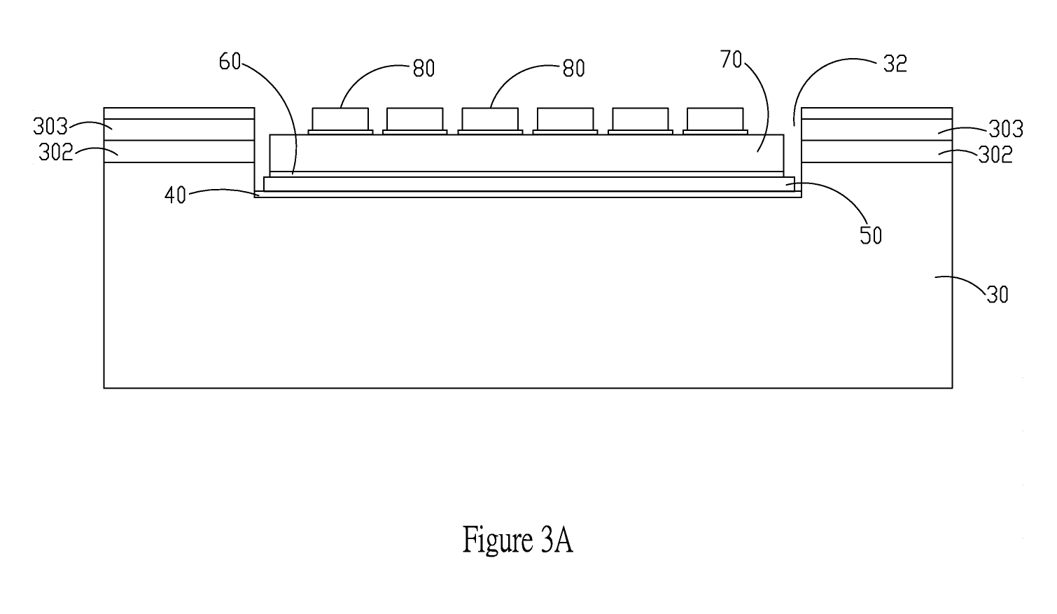

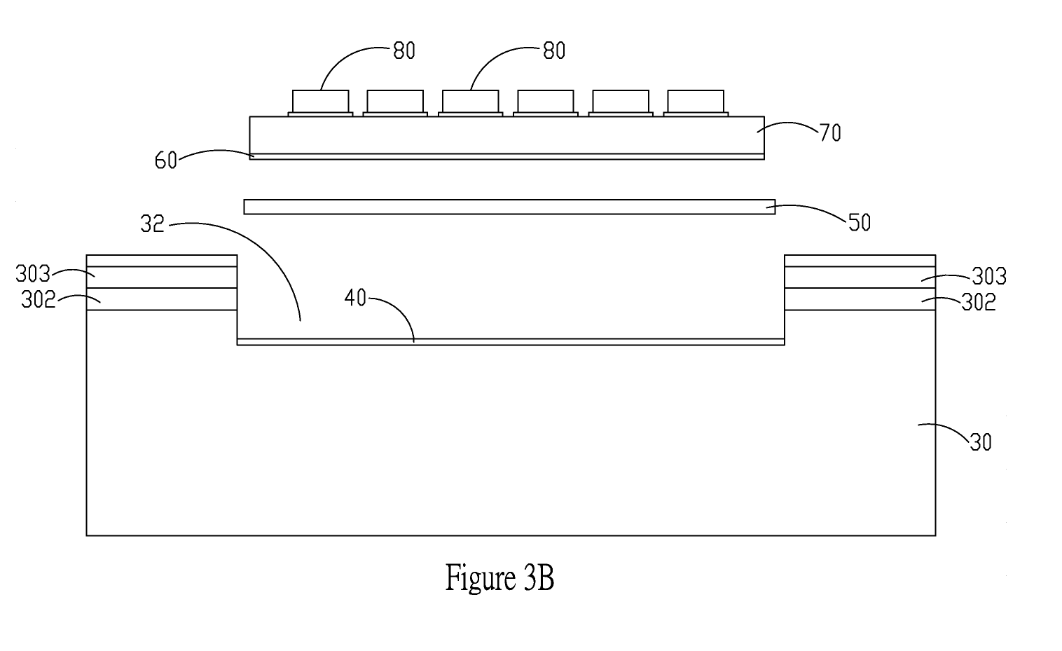

FIGS. 3A and 3B show an extended structure according to another preferred embodiment of the present invention. As shown in FIG. 3A, in order to increase convenience of electrical connection and to reduce high thermal spreading resistance produced by the insulation layer 302, while manufacturing the metal-core printed circuit board (MCPCB), a trench 32 can be set to form two regions on the MCPCB. Region one is the area outside of the trench 32 used for maintaining the original structure of the MCPCB, namely, the insulation layer 302 and the circuit layer 303. On the other hand, region two is the area inside of the trench 32, which is the heat sink substrate 30 excluding the insulation layer 302 and the circuit layer 303 of Cu or Al materials, and is used for binding with the circuit board with high thermal conductivity by means of the connection layer 50. The heat sink substrate 30 in the trench 32 is plated with the first attachment layer 40 of Ti/Ag or Ti/Au for increasing binding between the heat sink substrate 30 and the connection layer 50. Next, the second attachment layer 60 of Ti/Ag or Ti/Au is plated under the circuit board with high thermal conductivity 70 for increasing binding between the circuit board with high thermal conductivity 70 and the connection layer 50. The advantage of the extended structure is retaining the circuit layer 303 of the MCPCB while integrating the merit of low thermal resistance in the structure according to FIG. 2A. The solid-state lighting 80 is set on the circuit board with high thermal conductivity 70 according to the present structure can include multiple chips as well as series and parallel circuits. The circuits on the circuit board with high thermal conductivity 70 can connect with the circuit layer 303 of the MCPCB, and then connect to exterior circuits. Alternatively, a single solid-state lighting 80 chip can be adopted and circuit design can be implemented directly in the MCPCB. Using MCPCB to connect to exterior circuits is favorable for designing external wiring or external connectors, and can protect the solid-state lighting 80 from pulling and dragging by external forces and from damages. Thereby, the reliability of applications using the solid-state lighting 80 can be enhanced.

To sum up, the package structure for solid-state lighting with low thermal resistance according to the present invention comprises a heat sink substrate, a connection layer, a circuit board with high thermal conductivity, and a solid-state lighting. The connection layer is set on the heat sink substrate; the circuit board with high thermal conductivity is set on the connection layer; and the solid-state light is set on the circuit board with high thermal conductivity. By means of the connection layer, the thermal resistance of the package structure for solid-state lighting with low thermal resistance can be reduced. In addition, the thermal stress produced between the heat sink substrate and the circuit board with high thermal conductivity can be buffered for avoiding detachment of the circuit board with high thermal conductivity from the heat sink substrate owing to heat.

Accordingly, the present invention conforms to the legal requirements owing to its novelty, non-obviousness, and utility. However, the foregoing description is only a preferred embodiment of the present invention, not used to limit the scope and range of the present invention. Those equivalent changes or modifications made according to the shape, structure, feature, or spirit described in the claims of the present invention are included in the appended claims of the present invention.

1. A package structure for solid-state lighting with low thermal resistance, comprising:
a heat sink substrate;
a connection layer, set on the heat sink substrate;
a circuit board with high thermal conductivity, set on the connection layer; and
a solid-state lighting, set on the circuit board with high thermal conductivity;
wherein a first attachment layer is set between the heat sink substrate and the connection layer, and comprising a first metal layer and a second metal layer, and a second attachment layer is set between the connection layer and the circuit board with high thermal conductivity, and comprising a third metal layer and a fourth metal layer.

2. The package structure for solid-state lighting with low thermal resistance of claim 1, wherein the first metal layer is set on the heat sink substrate, the second metal layer is set on the first metal layer, the connection layer is set on the second metal layer, the third metal layer is set under the circuit board with high thermal conductivity, the fourth metal layer is set under the third metal layer, and the connection layer is set under the fourth metal layer.

3. The package structure for solid-state lighting with low thermal resistance of claim 2, wherein the material of the first metal layer includes titanium (Ti).

4. The package structure for solid-state lighting with low thermal resistance of claim 2, wherein the material of the second metal layer includes silver (Ag) or gold (Au).

5. The package structure for solid-state lighting with low thermal resistance of claim 2, wherein the material of the third metal layer includes titanium (Ti).

6. The package structure for solid-state lighting with low thermal resistance of claim 2, wherein the material of the fourth metal layer includes silver (Ag) or gold (Au).

7. The package structure for solid-state lighting with low thermal resistance of claim 1, wherein the material of the heat sink substrate includes metals.

8. The package structure for solid-state lighting with low thermal resistance of claim 7, wherein the material of the metals includes aluminum (Al) or copper (Cu).

9. The package structure for solid-state lighting with low thermal resistance of claim 1, wherein the material of the connection layer includes metals, alloys, o metallic composite materials, wherein the metals include indium (In).

10. The package structure for solid-state lighting with low thermal resistance of claim 1, wherein the material of the connection layer includes tin-silver-copper alloys or indium alloys.

11. The package structure for solid-state lighting with low thermal resistance of claim 1, wherein the material of the circuit board with high thermal conductivity includes ceramics or silicon (Si).

12. The package structure for solid-state lighting with low thermal resistance of claim 11, wherein the ceramics includes aluminum nitride (AlN) or aluminum oxide (Al₂O₃).

13. The package structure for solid-state lighting with low thermal resistance of claim 1, wherein a trench is set on the heat sink substrate, the connection layer is set in the trench, and the first attachment layer is set between the trench and the connection layer.

14. The package structure for solid-state lighting with low thermal resistance of claim 13, wherein an insulation layer and a circuit layer are set on the heat sink layer.

15. The package structure for solid-state lighting with low thermal resistance of claim 13, wherein the first metal layer is set on the trench, and the second metal layer is set on the first metal layer, and the connection layer is set on the second metal layer.

16. The package structure for solid-state lighting with low thermal resistance of claim 15, wherein the material of the first metal layer includes titanium (Ti).

17. The package structure for solid-state lighting with low thermal resistance of claim 15, wherein the material of the second metal layer includes silver (Ag) or gold (Au).
